(19) United States
(12) Patent Application Publication
(10) Pub. No.: US 2011/0197018 A1
(43) Pub. Date: Aug. 11, 2011

(54) METHOD AND SYSTEM FOR PERPETUAL COMPUTING USING NON-VOLATILE RANDOM ACCESS MEMORY

(76) Inventors: Sam Hyuk Noh, Seoul (KR); Hyojin Kim, Seoul (KR); Eunsam Kim, Seoul (KR); Jong Moo Choi, Gyeonggi-do (KR); Dong Hee Lee, Seoul (KR); Young-Je Moon, Seoul (KR); In Hwan Doh, Seoul (KR); Jung-Soo Park, Seoul (KR)

(21) Appl. No.: 13/122,722

(22) PCT Filed: Oct. 6, 2009
(86) PCT No.: PCT/KR2009/005684

§ 371 Date: Apr. 5, 2011

(30) Foreign Application Priority Data
Oct. 6, 2008 (KR) 10-2008-0097581
Feb. 18, 2009 (KR) 10-2009-0013463

(51) Int. Cl. G06F 12/02

(52) U.S. Cl. 711/103; 711/102; 711/E12.007; 711/E12.008

(57) ABSTRACT

Provided is a computing system and method that utilizes a non-volatile random access memory (NVRAM). A system including the NVRAM as a part of a memory or a whole memory may execute a program in the NVRAM, and, when the system is re-operated after being shut down, may restore a state and data of the program being executed in the NVRAM to an original state and thus, may provide a permanent computing environment.

### TECHNICAL FIELD

The present invention relates to a method and system that may provide a permanent computing environment regardless of physical interference.

### BACKGROUND ART

Recently, researches on improving a speed of on and off operations of a computing system have been actively conducted. Although a time from when a power-on command is provided to the computing system to when the computing system is able to operate may be different for each system, a boot-time expended for initiating a system and a device driver in a personal computer or a server system is relatively long and thus, a relatively large amount of energy and a time may be wasted.

A time consumed for performing a system-on operation may be a big issue for electronic devices having various functions, such as a digital television (TV), a mobile terminal, and a navigation terminal, and the like, in addition to the personal computer or the server system.

The research on improving speed of a system-on operation or a boot operation have been conducted in several schemes including a scheme that reduces a time expended for reading the executable files and storing the executable file in a main memory by storing in a flash memory-based device, that has a higher read access speed than a general hard disk, executable files of a start-up program or an operating system that is accessed when a system is booted, a scheme that utilizes a separate operating system that has a smaller executable image than a general-purpose operating system and includes a minimum service function, and a scheme that is based on a suspend to disk scheme or a suspend to RAM scheme, and the like.

The suspend to disk scheme may store data of a system, managed in a volatile medium, such as data of a central processing unit (CPU) register, data of a cache, data of a peripheral device, data of a main memory, in a storage medium, such as a hard disk and the like, that is accessible based on a block unit, and may power the system off.

The suspend to RAM scheme may store volatile information associated with a CPU or a peripheral device in a volatile main memory, and may provide a minimum power only to the main memory and may turn off power supplied to other devices and thus, may exhibit as if the system is powered off.

Even through the above conventional schemes each have individual merits, the suspend to RAM scheme may continuously consume a predetermined amount of power since the system is not actually powered off, and may have a limit to improving a boot time or a power-off time.

Accordingly, there is a desire for a computing system and method that minimizes or removes power consumption and that is able to perform instant power off, instant booting or instant power-on functions.

Conventionally, a flash memory has been used as a non-volatile memory. The flash memory may be classified into various types, such as a not And (NAND) flash memory, a not OR (NOR) flash memory, and the like, based on a structure of a memory cell array. A time expended for reading, writing, and erasing data in a memory in the flash memory may be relatively longer than a static random access memory (SRAM) or a dynamic random access memory (DRAM). Accordingly, the flash memory may be difficult to be used as the main memory of the computing system.

A non-volatile random access memory (NVRAM) that is non volatile and is byte-addressable, and consumes a similar amount of time for reading and writing data compared to the SRAM or the DRAM has been developed and has been widely utilized.

### DISCLOSURE

### Technical Goals

An aspect of the present invention provides a computing system and method that may execute a program in a non-volatile random access memory (NVRAM) and thus, may provide permanence to the program.

Another aspect of the present invention provides a computing system and method that may execute a program in an NVRAM and may restore the program to an original state of before power turn off, without overhead of an execution time and thus, may provide permanent computing.

Another aspect of the present invention provides a computing system and method that may sufficiently reduce a system on time and a power off time.

Another aspect of the present invention provides a computing system and method that may separately manage an internal device of the computing system (hereinafter module) that requires continuous power and a module that does not require continuous power and thus, may improve energy efficiency.

### Technical Solutions

According to an aspect of the present invention, there is provided a computing system, including a processor to execute a program, and a non-volatile random access memory (NVRAM) that does not lose stored data when power is turned off, is byte-addressable, and, while the program is being executed, stores at least one of data stored in a volatile medium. In this case, when the power is re-supplied after being turned off, the processor restores the at least one of data stored in the NVRAM, and restores a state of the program of before the power turn off.

According to an aspect of the present invention, there is provided a computing method, including storing, in an NVRAM, at least one of data stored in a volatile medium, while a program is being executed, the NVRAM not losing stored data when power is tuned off and being byte-addressable, detecting an event that power is re-supplied after being turned off, restoring the at least one of data stored in the NVRAM when the event is detected, and restoring a state of the program of before the power turn off, based on the restored data.

According to another aspect of the present invention, there is provided a computing system, including a processor to perform a computing operation, an NVRAM that does not lose stored data that corresponds to a program image being executed and data used for the program when power is turned off, is byte-addressable, and stores at least one of data stored in a volatile medium for the computing operation, a controller to store, in the NVRAM, at least one of the at least one of data to be used for computing operation and computing operation data associated with a second module group that does not require continuous power, when a command to turn the power off is received, and to continuously supply power only to a first module group that requires continuous power, and to turn off power supplied to a central processing unit (CPU), the NVRAM, and the second module group.

According to still another aspect of the present invention, there is provided a computing system, including a processor to perform a computing operation, an NVRAM that does not lose stored data when power is turned off, is byte-addressable, and stores at least one of data stored in a volatile medium for the computing operation, and a controller to restore the at least one of data from the NVRAM and to operate the processor and the NVRAM when a system instant-on command is received.

According to yet still another aspect of the present invention, there is provided a computing method, including storing, by a computing system in an NVRAM, at least one of data stored in a volatile medium for a computing operation of the computing system, while the computing system is being operated, and storing, by the computing system in the NVRAM, data that is not stored in the NVRAM among data stored in the volatile medium for the computing operation of the computing system, when a power-off command associated with the computing system is received, and turning power of the computing system off.

### Effects

According to the present invention, there may be provided a computing system and method that may enable permanent computing with a relatively small cost.

In this example, a system may be promptly restored to an original state of before system turn off, without performing initialization or a boot process and thus, convenience of utilizing the system may be improved. Further, the system may be stably operated when power failure suddenly occurs.

According to the present invention, a time expended for shutting down and re-booting a system is significantly short and thus, a time and energy expended for the re-booting the system may be reduced.

### BRIEF DESCRIPTION OF DRAWINGS

FIG. 1 is a diagram illustrating a computing system according to an embodiment of the present invention;

FIG. 2 is a diagram illustrating a computing system according to another embodiment of the present invention;

FIG. 3 is a flowchart illustrating an example of a computing method performed by the computing system of FIG. 1;

FIG. 4 is a flowchart illustrating an example of a computing method performed by the computing system of FIG. 2;

FIG. 5 is a diagram illustrating a computing system according to an embodiment of the present invention;

FIG. 6 is a diagram illustrating a configuration of a central processing unit (CPU) according to an embodiment of the present invention;

FIG. 7 is a diagram illustrating a configuration of a controller according to an embodiment of the present invention;

FIG. 8 is a diagram illustrating a computing method when power is turned off according to an embodiment of the present invention;

FIG. 9 is a diagram illustrating a computing method that separately processes a module that requires continuous power and a module that does not require continuous power when power is turned off according to an embodiment of the present invention;

FIG. 10 is a diagram illustrating a computing method when a power-off command associated with a computing system is performed according to an embodiment of the present invention.

FIG. 11 is a diagram illustrating a computing method when an instant-on command associated with a computing system is received according to an embodiment of the present invention; and

FIG. 12 is a diagram illustrating a computing method when an instant-on command associated with a computing system is received from an external system according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

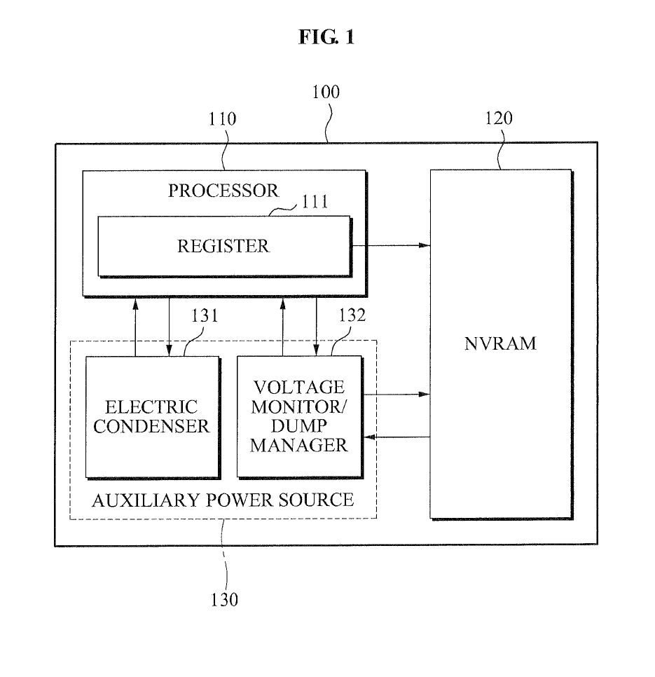

FIG. 1 illustrates a computing system 100 according to an embodiment of the present invention.

The computing system 100 may include a processor 110, a non-volatile random access memory (NVRAM) 120, and an auxiliary power source 130.

The NVRAM 120 may be byte-addressable and thus, access to the address may be performed using a physical address corresponding to a logical address that the processor 110 recognizes. Accordingly, the processor 110 may recognize the NVRAM 120 using a logical address space that the processor 110 recognizes. A program may be executed in the NVRAM 120 based on the characteristics of the NVRAM 120.

The NVRAM 120 may be non-volatile and may be randomly accessible. Examples of the NVRAM 120 may include a ferroelectric RAM (FRAM), a magnetoresistive RAM (MRAM), a phase-change RAM (PRAM), and the like. However, the present invention is not limited thereto.

The NVRAM 120 may permanently retain stored data when power is turned off. When the power is turned off while a program is being executed, the processor 110 may store, in the NVRAM 120, data stored in a volatile medium for a computing operation of the computing system 100, such as register data of a register 111 included in the processor 110, processor cache data of a processor cache (not illustrated), and data of volatile media of other peripheral devices (not illustrated).

When power is re-supplied after being turned off, the processor 110 may restore a state value included in the NVRAM 120 in the processor 110 and in a device. In this example, it is same as a case where the program is re-executed in a state of before the power turn off and thus, computing may be permanently performed.

The volatile medium may be a volatile storage device that loses stored data when power is turned off, and may be a storage to operate a computing system, such as a cache, a register of a processor, and the like. A main memory may not be included in the computing system.

Throughout the specifications, it should be understood that a volatile medium includes various volatile storage devices, such as a register, a cache, and the like.

The computing system 100 may be restored to an original state without data loss even through power was suddenly turned off and thus, the program may be safely executed without data loss.

The computing system 100 of FIG. 1 may not include a volatile RAM and may include the NVRAM 120 corresponding to an entire memory area. In this example, a configuration of the memory may be relatively simple and thus, may be more applicable to an embedded system.

The register 111 of the processor 110 may store an operation value while the program is being executed. The register 111 may be a volatile memory that loses stored data when power is turned off. Data of the program and state information may be stored in the NVRAM 120, and the processor 110 may access the NVRAM 120 using an address.

An electric condenser 131 and a voltage monitor/dump manager 132 may operate to enable the processor 110 to store, in the NVRAM 120, contents stored in the register 111 that is volatile and contents stored in the volatile medium (not illustrated). When a voltage becomes lower than a reference value, the voltage monitor/dump manager 132 may regard that power of the computing system 100 is turned off and may control the processor 110 to store, in a predetermined area of the NVRAM 120, contents stored in the register 111 and the volatile medium (not illustrated). The contents stored in the NVRAM 120 may be retained when the power is turned off.

The electric condenser 131 may be used for maintaining a voltage of the power of the computing system 100, while the voltage monitor/dump manager 132 or the processor 110 safely stores, in the NVRAM 120, contents stored in the register 111 and the volatile medium. The voltage monitor/dump manager 132 may be embodied as hardware and software.

In an environment where the NVRAM 120 corresponds to the entire memory area as illustrated in FIG. 1, all programs executed in the computing system 100 may be executable in the NVRAM 120. Accordingly, when the computing system 100 stores, in the NVRAM 120, contents stored in the register 111 and the volatile medium, permanence of the all programs may be assured.

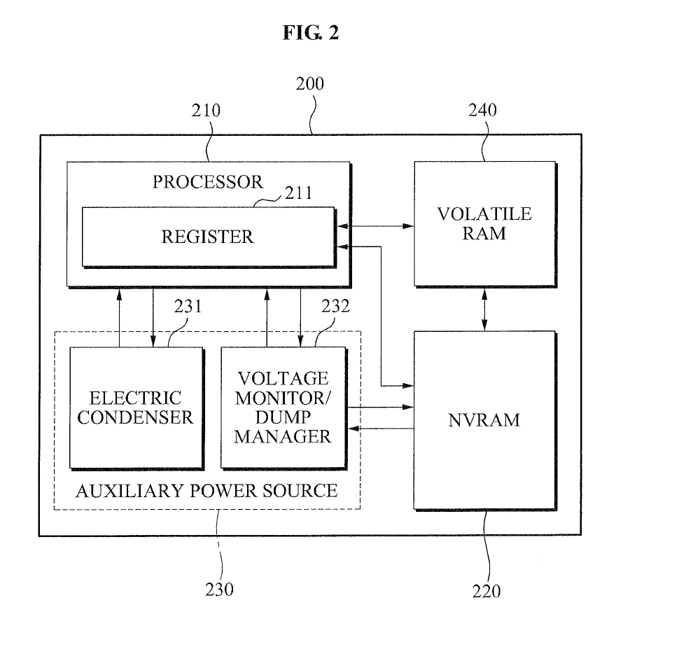

FIG. 2 illustrates a computing system 200 according to another embodiment of the present invention.

The computing system 200 may include a processor 210, a NVRAM 220, an auxiliary power source 230, and a volatile RAM 240.

Referring to FIG. 2, a memory area may be embodied as the NVRAM 220 and the volatile RAM 240, and an address space that the processor 210 recognizes may correspond to the NVRAM 220 and the volatile RAM 240. In applications, such as a general personal computer, a server system, and the like, the NVRAM 240 and the volatile RAM 220 may be used together.

A program executed by the processor 210 may be executed in the NVRAM 240 or the volatile RAM 220. The processor 210 may store in the NVRAM 240 or in the volatile RAM 220, contents stored in the register 211, as occasion demands. The volatile RAM 240 may lose stored data when power is turned off. Therefore, the volatile RAM 240 may set a data preservation command or a permanence preservation command, and may store, in the NVRAM 220, the contents stored in the register 211 and the volatile medium, when the data preservation command or the permanence preservation command is issued and thus, permanence may be provided.

Referring to FIG. 2, a command that the processor 210 stores, in the NVRAM 240, contents to be used for restoring the program among the contents stored in the register 211 and contents stored in the volatile medium or the volatile RAM 240 may be issued. In this example, the command may be referred to as the data preservation command or the permanence preservation command.

The auxiliary power source 230 may include an electric condenser 231 and the voltage monitor/dump manager 232. The electric condenser 231 may maintain a voltage of the power of the computing system 200 to be a predetermined level when an event that the power is turned off is detected. The voltage monitor/dump manager 232 may generate the data preservation command or the permanence preservation command, as occasion demands.

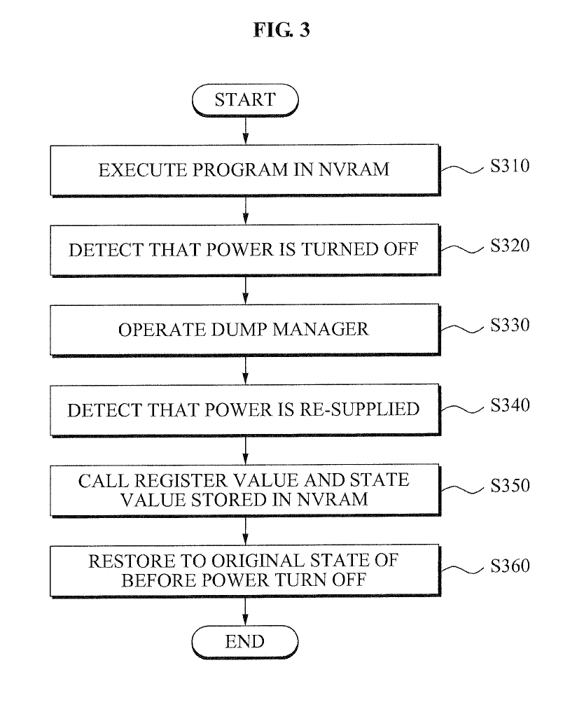

FIG. 3 illustrates an example of a computing method performed by the computing system 100 of FIG. 1

The computing system 100 may execute a program in the NVRAM 120 in operation S310. The program may be generated and executed in the NVRAM 120. In this example, the computing system 100 may operate stably.

When the voltage monitor/dump manager 132 detects that power is turned off in operation S320, the computing system 100 may operate the dump manager in operation S330. In this example, the program may be executed in the NVRAM 120 and thus, the computing system 100 may store state information associated with the program in the NVRAM 120 without burden of cost.

The electric condenser 131 may maintain a voltage of the power of the computing system 100 to be a predetermined level while a state value of the register and the volatile medium (not illustrated) is stored in the NVRAM 120. The dump manager may store contents stored in the register 111 and the volatile medium, in a predetermined address of the NVRAM 120.

In this example, information associated with all programs to be executed may be safely stored in the NVRAM 120 and may be permanently retained. When electric charges in the electric condenser 131 are exhausted or the dump manager explicitly commands a power-off command, the power of the computing system 100 may be turned off.

When the voltage monitor detects that power is re-supplied in operation S340, the computing system 100 may call, to the register 111, information stored in the predetermined address of the NVRAM 120 in operation S350. In this example, the called information may include a register value of the register 111 and a state value.

The computing system 100 may be restored to an original state of before the power turn off, based on the called value in operation S360.

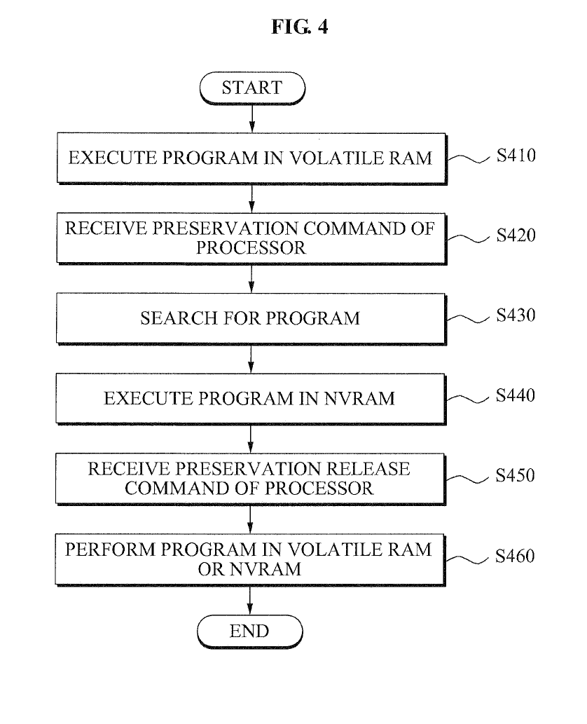

FIG. 4 illustrates an example of a computing method performed by the computing system 200 of FIG. 2.

The computing system 200 may execute a program in a volatile RAM 240 in operation S410

When a data preservation command or a permanence preservation command of the processor 210 is received in operation S420, the computing system 210 may search for a program of which permanence is requested in operation S430.

Even though it is not restricted, the data preservation command may be embodied based on a command such as a system call and the like, and may be generated by the voltage monitor/dump manager 232, in addition to by the processor 210.

In operation S430, the computing system 200 may search for the program of which permanence is requested, and may obtain an address of the volatile RAM 240 where state information and data corresponding to the retrieved program are stored.

The computing system 200 may read, from the obtained address of the volatile RAM 240, the state information and the data corresponding to the program. The computing system 200 or the dump manager 232 may store the read data and the state information in the NVRAM 220 based on the data preservation command.

Even through the data preservation command may be embodied by various schemes, the data preservation command may be embodied by copying data of previously allocated volatile RAM object to an NVRAM. The program of which permanence is requested may be stored in the NVRAM 220 and thus, the permanence may be retained when power is turned off.

The computing system 200 may execute the program of which permanence is requested in NVRAM 220 in operation 5440.

When a power-off event is detected by the voltage monitor 232, operations similar to operations S320 through S360 of FIG. 3 may be performed and thus, the permanence of the program may be retained. In this example, a register value of the register 211 and a value of a volatile medium (not illustrated) may be stored in the NVRAM 220, as occasion demands.

When the computing system 200 determines not to retain the permanence of the program, the computing system 200 may provide a preservation release command with respect to the program.

When the preservation release command is received in operation S450, the computing system 200 may execute the program in the volatile RAM 240. In this example, the computing system 200 may store, in the volatile RAM 240, the state information and the data of the program stored in the NVRAM 220. The computing system 200 may store the state information and the data of the program in the NVRAM 220, and may mark that the preservation of the permanence is released, on a data structure to be used for managing the program.

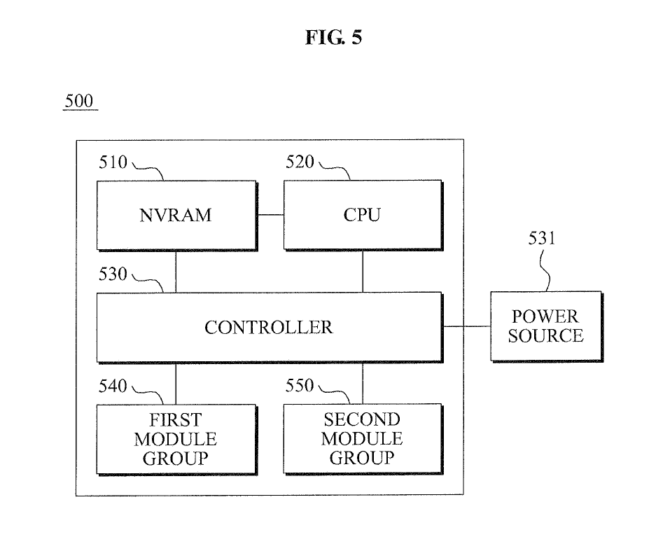

FIG. 5 illustrates a computing system 500 according to an embodiment of the present invention.

The computing system 500 may include an NVRAM 510, a central processing unit (CPU) 520, and a controller 530.

The NVRAM 510 may be byte-addressable and thus, the access may be performed based on a physical address corresponding to a logical address that the CPU 520 recognizes.

Accordingly, the CPU 520 may recognize the NVRAM 510 based on the logical address space that the CPU 520 recognizes. A program may be executed in the NVRAM 510 based on characteristics of the NVRAM 510.

The NVRAM 510 may be non-volatile and randomly accessible. The NVRAM 510 may permanently or semi-permanently retain stored data when power is suddenly turned off.

When the power of the computing system 500 is turned off while the program is being executed, the controller 530 may store, in the NVRAM 510, a state value of a register associated with volatile data included in the CPU 520, state values of peripheral devices, such as a first module group 540, a second module group 550, and the like, and a processor cache, such as a CPU cache, and the like.

The controller 530 may turn the power of the computing system 500 off and thus, instant power off may be performed without data loss.

According to an embodiment of the present invention, the controller 530 may classify the computing system 500 into the first module group 540 that requires continuous power and the second module group 550 that does not require continuous power, and may separately manage the first module group 540 and the second module group 550.

The first module group 540 may include a sensor network module, a network adaptor module, an external communication module of a mobile terminal, a global positioning system (GPS) receiving module, a facsimile (FAX) communication receiving module, a communication receiving module of a printer, an external communication receiving module of a digital television (TV), a communication receiving module of a home network system, and the like.

The second module group 550 may include a hard disk, a volatile RAM, a flash memory, an embedded system module of a mobile terminal, a GPS navigation system module, a FAX printing module, a printing module of a printer, a driving module of a digital TV, a driving module of a home network system, and the like.

According to example embodiments, the computing system 500 may be a personal computer, a server system, a mobile terminal, such as portable phone and the like, a navigation terminal, a FAX terminal, a printer terminal, a digital TV, and a home network system.

According to example embodiments, a terminal or a system that expends a relatively long time to initiate the terminal or system by re-supplying power after tuning the power off, such as the GPS receiving module and the like, and a terminal or a system of which power is always turned on for communication purpose, such as the receiving module of the mobile terminal, the receiving module of the FAX terminal, and the like, may be classified as the first module group 540 that requires the continuous power, and the controller 530 may manage power separately from a operation of turning off the computing system 500.

The second module group 550 that is different from a first module group 540 may not require continuous power and thus, the controller 530 may not provide power when the computing system 500 is turned off.

When the power is re-supplied to the computing system 500, for example, by receiving an instant-on command and the like, the controller 530 may restore a state value stored in the NVRAM 510 in the register 610 and a device, and the stored state value may include a program image, data used in the program, and the like. In this example, it is the same as a case where the program is re-executed in a state of before the power turn off and thus, instant-on may be performable.

In this example, the first module group 540 may be provided with continuous power and thus, instant-on may be applicable to the second module group 550, the NVRAM 510, and the CPU 520.

The computing system 500 may be restored to an original state when the power is suddenly turned off and thus, may safely perform the program without data loss.

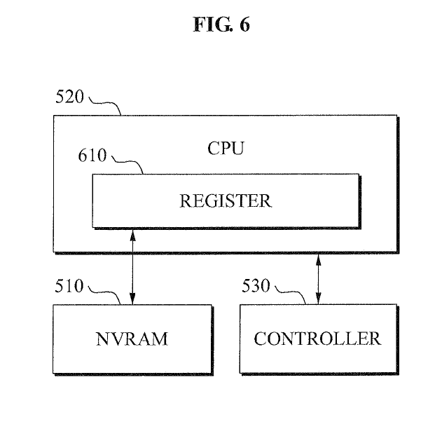

FIG. 6 illustrates a configuration of the CPU 520 according to an embodiment of the present invention.

According to an embodiment, the CPU 520 may include a register 610. The register may be loaded with data from the NVRAM 510 that is used as a main memory, and may use the data for calculation of the CPU 520.

Referring to FIG. 5, when the power of the computing system 500 is turned off while the program is being executed, the controller 530 may store, in the NVRAM 510, data of a volatile medium, for example the register 610, and state values of peripheral devices, for example, the first module group 540, the second module group 550, and the like.

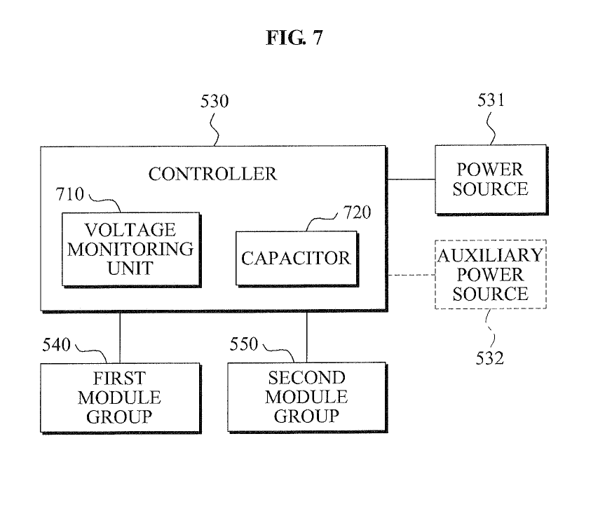

FIG. 7 illustrates a configuration of the controller 530 according to an embodiment of the present invention.

According to an embodiment, the controller 530 may further include a voltage monitoring unit 710 that monitors a supply voltage of power.

The voltage monitoring unit 710 may monitor whether the supply voltage of the power of the power source 531 is less than or equal to a first threshold.

A case where the supply voltage is less than or equal to the first threshold may correspond to a case where power is inadvertently not supplied due to a power outage and the like. The first threshold may be set differently for each system, and a voltage value that is less than a rated voltage required for operating a corresponding system and that is insufficient for stable system operation may be selected as the first threshold.

When the voltage monitoring unit 710 detects that the supply voltage of the power supplied from the power source 531 is less than or equal to the first threshold, the controller 530 may store, in the NVRAM, at least one of data stored in a volatile medium for a computing operation, for example, at least one of data of a register of a processor, a state value of the peripheral device, and computing operation data associated with a second module group that does not require the continuous power, and may continuously supply power only to a first module group and may immediately turn off the power supplied to the CPU, the NVRAM, and the second module group.

The controller may further include a capacitor 720.

When the voltage monitoring unit 710 detects that the supply voltage supplied from the power source 531 is less than or equal to the first threshold, the capacitor 720 may supply power to the controller 530 during a first reference time.

According to an embodiment, the system 500 may be provided with power from an auxiliary power source 532, as opposed to the power source 531 which is a main power source.

In this example, the auxiliary power source 532 may be an uninterruptible power system (UPS) or a battery.

According to an embodiment, when the controller 530 immediately performs a power off process as described in FIG. 5 since the power source 531 is not able to supply power any longer due to a breakdown, a broken wire, and the like, the capacitor 720 may perform voltage sustaining during the first reference time where the controller 530 turns off the power supplied to the NVRAM 510, the CPU 520, and the second module group 550, and supplies power to the first module group 540 using the auxiliary power source 532.

The controller 530 may be included in the system 500. Even through the controller 530 is located outside the system 500 and performs the described role, it should be understood within the principles and spirit of the invention.

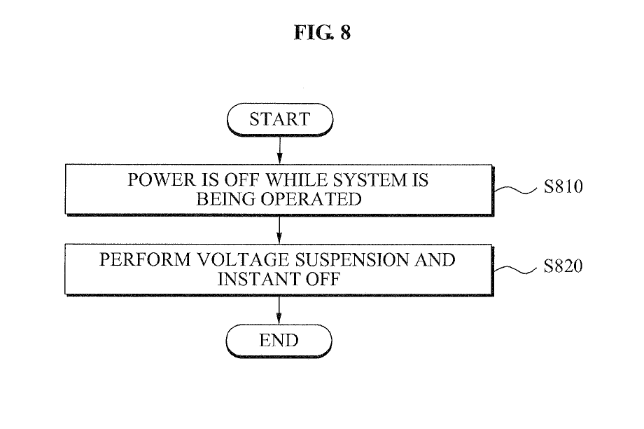

FIG. 8 illustrates a computing method when power is turned off according to an embodiment of the present invention.

In operation S810, power may be suddenly turned off while the computing system 500 is being operated. The power outage may be caused by a breakdown of the power source 531 or a broken wire.

In this example, the controller 530 may store, in the NVRAM 510, at least one of data stored in a volatile medium, such as a state value of the register 610 associated with volatile data included in the CPU 520, state values of peripheral devices, such as the first module group 540 and the second module group 550, and the like.

The controller 530 may turn the power of the computing system 500 off and thus, instant power off may be performed without data loss.

According to an embodiment, when the auxiliary power source 532 exists, the controller 530 may supply, using the auxiliary power source 532, power to the first module group 540 that requires continuous power. In this example, the capacitor 720 may perform voltage sustaining.

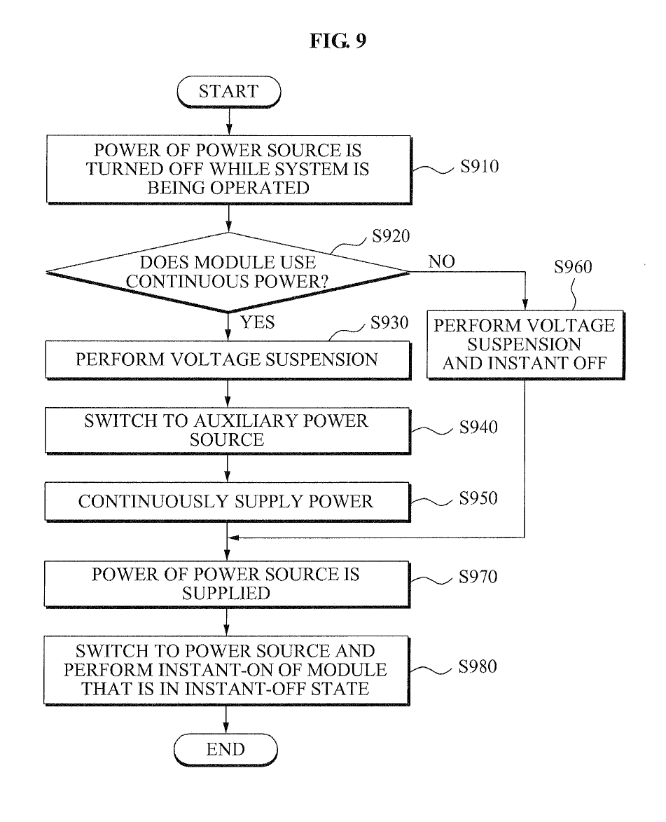

A process that separately processes the first module group 540 and the second module group 550 will be described with reference to FIG. 9.

FIG. 9 illustrates a computing method that separately processes a module that requires continuous power and a module that does not require continuous power when power is turned off according to an embodiment of the present invention.

In operation S910, an event where power of the power source 531 is suddenly turned off may occur while the computing system 500 is being operated. The event may be monitored by the voltage monitoring unit 710.

In operation S920, the controller 530 may distinguish the first module group 540 that requires continuous power and the second module group 550 that does not require continuous power. Examples of the first module group 540 and the second module groups 550 have been described in the description with reference to FIG. 5.

In operation S930, the capacitor 720 may perform voltage sustaining for the first module group 540 that requires the continuous power.

When the auxiliary power source 532 exists, the controller 530 may supply power to the first module group 540 using the auxiliary power source 532.

Accordingly, the first module group 540 may be provided with the continuous power and thus, the first module group 540 may communicate with an external system in operation S950.

In operation S960, voltage sustaining and an instant-off process may be performed for the second module 550 that does not require the continuous power. The instant-off process has been described in the description with reference to FIGS. 5 and 6.

When a power supply event or an instant-on command associated with the power supply 531 occurs in operation S970, the controller 530 may be provided with power from the power source 531 instead of the auxiliary power 532, may supply the provided power to the computing system 500, and may restore a state value stored in the NVRAM 510 in the register 610 and the device. Accordingly, the instant-on process may be completed, and data loss and system damage may be prevented during the instant-on process.

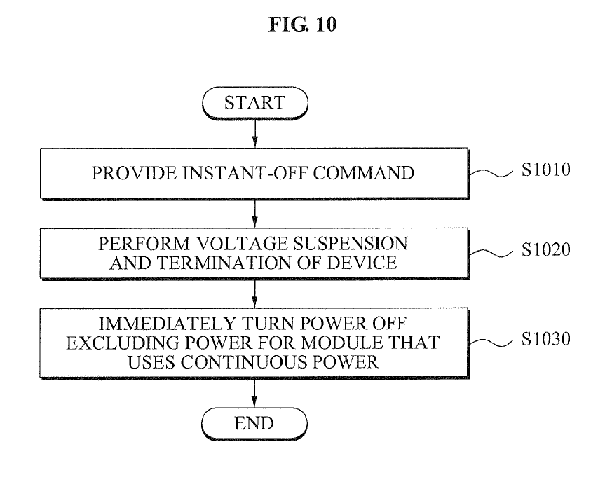

FIG. 10 illustrates a computing method when a power-off command associated with a computing system is performed according to an embodiment of the present invention.

In operation S1010, an instant-off command may be received. The instant-off command may be recognized by a termination command in an operating system. In a case of the home network system, the instant-off command may be recognized when a user pushes a power button or may be recognized by receiving a system termination command from an outside device.

Voltage sustaining and termination of a device may be performed in operation S1020, and power for remaining devices, excluding power for the first module group 540, may be turned off in operation S1030. The operations have been described in the description with reference to FIGS. 5 and 6.

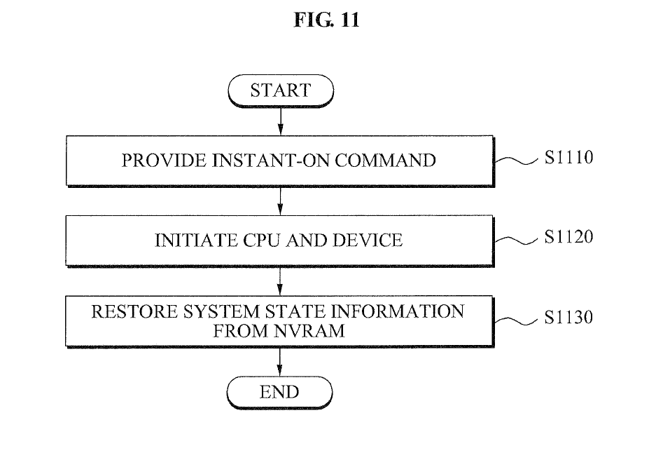

FIG. 11 illustrates a computing method when an instant-on command associated with a computing system is received according to an embodiment of the present invention.

In operation S1110, an instant-on command may be received. The instant-on command may be recognized when a user of the computing system pushes a power button or may be recognized by receiving the instant-on command from an outside device.

In operation S1120, the controller 530 may initiate the CPU 520 and each device.

In operation S1130, the controller 530 may restore, in the register 610 and the device, a state value stored in the NVRAM 510. Accordingly, the instant-on process may be completed, and a state of the computing system 500 and the program may be the same as a state of before the power turn off.

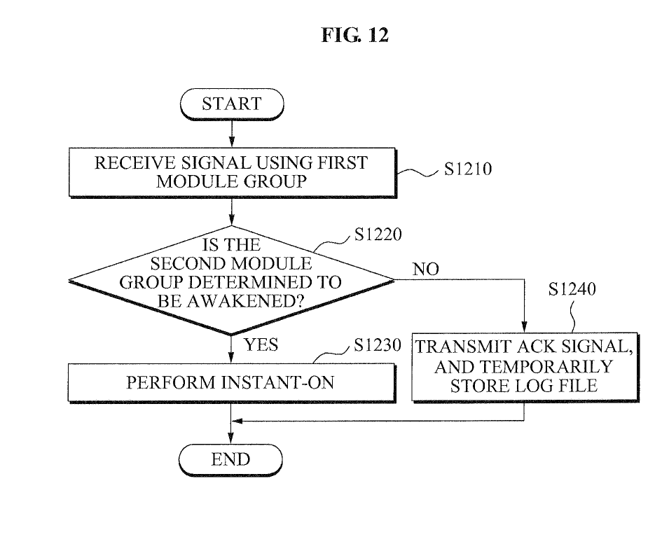

FIG. 12 illustrates a computing method when a computing system receives a communication signal from an external system according to an embodiment of the present invention.

In operation S1210, the communication signal may be received from an external system using the first module group 540, under condition that power is supplied only to the first module group 540 of the computing system 500 and power supplied to remaining devices is turned off.

In this example, the communication signal may be a call request or a message reception request in a case of a mobile terminal, may be FAX message reception request in a case of a FAX terminal, and may be a document print request in a case of a printer.

In operation S1220, whether to perform wake-up process with respect to the second module group 550 and the computing system 500 for which power is currently turned off may be determined.

In this example, whether the communication signal satisfies a predetermined condition may be determined. The predetermined condition may include a condition that the external system is registered in advance, for example, a call request from a registered phone number in a case of the mobile terminal, and a condition that the instant-on command in a pattern registered in advance, for example, an emergency alert message and the like in a case of the mobile terminal.

When the communication signal satisfies the predetermined condition and it is determined to awake the second module group 550 and the computing system 500, an instant-on process with respect to the computing system 500 may be performed in operation S1230. The instant-on process has been described in the description with reference to FIGS. 5 and 6.

When the communication signal does not satisfy the condition, and it is determined there is no need to wake-up the second module group 550 and the computing system, the controller 530 may transmit a acknowledgement (ACK) signal to the external system that transmits the communication signals, may generate a log file with respect to the communication signal, and may store the log file in the NVRAM 510. The log file may be read as occasion demands, after the instant-on process is completed with respect to the computing system 500.

In the case of the mobile terminal, a call request history, a text, and the like may be read after whole power is turned on.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A computing system, comprising:
a processor to execute a program; and
a non-volatile random access memory (NVRAM) that does not lose stored data when power is turned off, is byte-addressable, and, while the program is being executed, stores at least one of data stored in a volatile medium,
wherein, when the power is re-supplied after being turned off, the processor restores the at least one of data stored in the NVRAM, and restores a state of the program of before the power turn off.

2. The computing system of claim 1, further comprising:
a power-off detecting unit to detect an event where a supply voltage of the power is less than a threshold,
wherein the NVRAM stores a register value and a state value when the event is detected.

3. The computing system of claim 2, further comprising:
an auxiliary power source to maintain the supply voltage of the power to be a predetermined level, during a reference time when the event is detected,
wherein the NVRAM stores the register value and the state value during the reference time.

4. The computing system of claim 1, wherein:
the processor performs a preservation command;
the NVRAM stores, based on the preservation command, a register value and a state value.

5. The computing system of claim 4, wherein the processor explicitly or implicitly performs the preservation command.

6. The computing system of claim 4, further comprising:
a volatile memory that loses stored data when the power is turned off,
wherein the NVRAM stores, based on the preservation command, the data stored in the volatile memory.

7. A computing system, comprising:
a processor to perform a computing operation;
a non-volatile random access memory (NVRAM) that does not lose stored data when power is turned off, is byte-addressable, and stores at least one of data stored in a volatile medium for the computing operation; and
a controller to store, in the NVRAM, at least one of the at least one of data to be used for computing operation and computing operation data associated with a second module group that does not require continuous power, when a command to turn the power off is received, and to continuously supply power only to a first module group that requires continuous power, and to turn off power supplied to a central processing unit (CPU), the NVRAM, and the second module group.

8. The computing system of claim 7, wherein the controller further comprises a voltage monitoring unit to monitor a supply voltage of the power,
wherein, when the monitoring unit detects that the supply voltage of the power is less than or equal to a first threshold, the controller stores, in the NVRAM, at least one of the at least one of data stored in the volatile media for computing operation and the computing operation data associated with the second module group, and continuously supplies power only to a first module group that requires continuous power and turns off power supplied to a CPU, the NVRAM, and the second module group.

9. The computing system of claim 7, wherein the controller further comprises:
a voltage monitoring unit to monitor a supply voltage of the power; and
a capacitor to supply power to the controller during a first reference time when the monitoring unit detects that the supply voltage of the power is less than or equal to the first threshold,
wherein, when the monitoring unit detects that the supply voltage of the power is less than or equal to the first threshold, the controller stores, in the NVRAM, at least one of the at least one of data stored in the volatile media for computing operation and the computing operation data associated with a second module group, and continuously supplies power only to a first module group that requires continuous power and turns off power supplied to a CPU, the NVRAM, and the second module group.

10. The computing system of claim 7, wherein the first module group comprises at least one of a sensor network module, a network adaptor module, an external communication module of a mobile terminal, a global positioning system (GPS) receiving module, a facsimile (FAX) communication receiving module, a communication receiving module of a printer, an external communication receiving module of a digital television (TV), and a communication receiving module of a home network system.

11. The computing system of claim 7, wherein the second module group comprises at least one of a hard disk, a volatile RAM, a flash memory, an embedded system module of a mobile terminal, a GPS navigation system module, a FAX printing module, a printing module of a printer, a driving module of a digital TV, and a driving module of a home network system.

12. The computing system of claim 7, wherein, when the first module group receives an instant-on command associated with the computing system from an external system, the controller determines whether the instant-on command satisfies a predetermined condition, and, when the instant-on command satisfies the predetermined condition, restores the at least one of data from the NVRAM, to operate the processor and the NARAM, the predetermined condition including at least one of a condition that the external system is a system registered in advance and a condition that the instant-on command is in a pattern registered in advance.

13. The computing system of claim 7, wherein, when the first module group receives an instant-on command associated with the computing system from an external system, the controller determines whether the instant-on command satisfies a predetermined condition, and, when the instant-on command does not satisfy the predetermined condition, temporarily supplies power to the NVRAM, to store a log file associated with the reception of the instant-on command, the predetermined condition including at least one of a condition that the external system is a system registered in advance and a condition that the instant-on command is in a pattern registered in advance.

14. A computing system, comprising:
a processor to perform a computing operation;
a non-volatile random access memory (NVRAM) that does not lose stored data when power is turned off, is byte-addressable, and stores at least one of data stored in a volatile medium for the computing operation; and
a controller to restore the at least one of data from the NVRAM and to operate the processor and the NVRAM when a system instant-on command is received.

15. The computing system of claim 14, wherein, the controller continuously supplies power to a first module group that requires continuous power when the power is turned off, and supplies power to the processor, the NVRAM, and a second module group that does not require continuous power and restores the at least one of data from the NVRAM when the system instant-on command is received.

16. The computing system of claim 15, wherein, when the first module group comprises at least one of a sensor network module, a network adaptor module, an external communication module of a mobile terminal, a global positioning system (GPS) receiving module, a facsimile (FAX) communication receiving module, a communication receiving module of a printer, an external communication receiving module of a digital television (TV), and a communication receiving module of a home network system.

17. The computing system of claim 15, wherein the second module group comprises at least one of a hard disk, a volatile RAM, a flash memory, an embedded system module of a mobile terminal, a GPS navigation system module, a FAX printing module, a printing module of a printer, a driving module of a digital TV, and a driving module of a home network system.

18. The computing system of claim 15, wherein, when the first module group receives the system instant-on command from an external system, the controller determines whether the system instant-on command satisfies a predetermined condition, and, when the system instant-on command satisfies the predetermined condition, restores the at least one of data from the NVRAM, to operate the processor and the NARAM, the predetermined condition including at least one of a condition that the external system is a system registered in advanced and a condition that the instant-on command is in a pattern registered in advance.

19. The computing system of claim 15, wherein, when the first module group receives an instant-on command associated with the computing system from the external system, the controllers determines whether the instant-on command satisfies a predetermined condition, and, when the instant-on command does not satisfy the predetermined condition, temporarily supplies power to the NVRAM, to store a log file associated with the reception of the instant-on command, the predetermined condition including at least one of a condition that the external system is a system registered in advance and a condition that the instant-on command is in a pattern registered in advance.

20. A computing method, comprising:
storing, by a computing system in a non-volatile random access memory (NVRAM), at least one of data stored in a volatile medium for a computing operation of the computing system, while the computing system is being operated; and
storing, by the computing system in the NVRAM, data that is not stored in the among data stored in the volatile medium for the computing operation of the computing system, when a power-off command associated with the computing system is received, and turning power of the computing system off.

21. The computing method of claim 20, further comprising:
storing, by the computing system in the NVRAM, computing operation data associated with a second module group that does not require continuous power before turning off the power of the computing system, when the power-off command is received.

22. The computing method of claim 20, further comprising:
continuously supplying, by the computing system, power to a first module group that requires continuous power, when the power-off command is received.

23. The computing method of claim 20, further comprising:
restoring, by the computing system, data stored in the NVRAM from the NVRAM, to perform instant-on of the computing system when an instant-on command associated with the computing system is received.

24. The computing method of claim 20, wherein, when the instant-on command associated with the computing system is received from an external system, the computing method further comprises:
determining whether the instant-on command satisfies a predetermined command, the predetermined command including a condition that the external system is a system registered in advance and a condition that the instant-on command is in a pattern registered in advance; and
restoring, by the computing system, the data stored in the NVRAM from the NVRAM to perform instant-on of the computing system when the instant-on command satisfies the predetermined condition.

25. The computing method of claim 24, further comprising:
temporarily supplying, by the computing system, power to the NVRAM, to store a log file associated with the reception of the instant-on command when the instant-on command does not satisfy the predetermined condition.

26. A computing method, comprising:
storing, in a non-volatile random access memory (NVRAM), at least one of data stored in a volatile medium, while a program is being executed, the NVRAM not losing stored data when power is tuned off and being byte-addressable;
detecting an event that power is re-supplied after being turned off;
restoring the at least one of data stored in the NVRAM when the event is detected; and
restoring a state of the program of before the power turn off, based on the restored data.

27. The computing method of claim 26, further comprising:
detecting a power-off event corresponding to a case where a supply voltage of the power is less than a predetermined threshold,
wherein the storing comprises storing, in the NVRAM, the at least one of data stored in the volatile medium when the power-off event is detected.

28. The computing method of claim 27, further comprising:
maintaining the supply voltage of the power to be a predetermined level during a reference time when the power-off event is detected,
wherein the storing comprises storing, in the NVRAM, the at least one of data stored in the volatile medium during a reference time.

29. The computing method of claim 26, wherein the storing comprises storing the at least one of data stored in the volatile medium in response to a preservation command of a processor.

30. The computing method of claim 29, further comprising:
storing, in the NVRAM, the data stored in the volatile memory, in response to the preservation command, the volatile memory losing stored data when power is turned off.

31. At least one medium comprising computer readable instructions implementing the method of claim 20.

32. The computing system of claim 8, wherein the first module group comprises at least one of a sensor network module, a network adaptor module, an external communication module of a mobile terminal, a global positioning system (GPS) receiving module, a facsimile (FAX) communication receiving module, a communication receiving module of a printer, an external communication receiving module of a digital television (TV), and a communication receiving module of a home network system.

33. The computing system of claim 8, wherein the second module group comprises at least one of a hard disk, a volatile RAM, a flash memory, an embedded system module of a mobile terminal, a GPS navigation system module, a FAX printing module, a printing module of a printer, a driving module of a digital TV, and a driving module of a home network system.

34. The computing system of claim 8, wherein, when the first module group receives an instant-on command associated with the computing system from an external system, the controller determines whether the instant-on command satisfies a predetermined condition, and, when the instant-on command satisfies the predetermined condition, restores the at least one of data from the NVRAM, to operate the processor and the NARAM, the predetermined condition including at least one of a condition that the external system is a system registered in advance and a condition that the instant-on command is in a pattern registered in advance.

35. The computing system of claim 8, wherein, when the first module group receives an instant-on command associated with the computing system from an external system, the controller determines whether the instant-on command satisfies a predetermined condition, and, when the instant-on command does not satisfy the predetermined condition, temporarily supplies power to the NVRAM, to store a log file associated with the reception of the instant-on command, the predetermined condition including at least one of a condition that the external system is a system registered in advance and a condition that the instant-on command is in a pattern registered in advance.

36. The computing system of claim 9, wherein the first module group comprises at least one of a sensor network module, a network adaptor module, an external communication module of a mobile terminal, a global positioning system (GPS) receiving module, a facsimile (FAX) communication receiving module, a communication receiving module of a printer, an external communication receiving module of a digital television (TV), and a communication receiving module of a home network system.

37. The computing system of claim 9, wherein the second module group comprises at least one of a hard disk, a volatile RAM, a flash memory, an embedded system module of a mobile terminal, a GPS navigation system module, a FAX printing module, a printing module of a printer, a driving module of a digital TV, and a driving module of a home network system.

38. The computing system of claim 9, wherein, when the first module group receives an instant-on command associated with the computing system from an external system, the controller determines whether the instant-on command satisfies a predetermined condition, and, when the instant-on command satisfies the predetermined condition, restores the at least one of data from the NVRAM, to operate the processor and the NARAM, the predetermined condition including at least one of a condition that the external system is a system registered in advance and a condition that the instant-on command is in a pattern registered in advance.

39. The computing system of claim 9, wherein, when the first module group receives an instant-on command associated with the computing system from an external system, the controller determines whether the instant-on command satisfies a predetermined condition, and, when the instant-on command does not satisfy the predetermined condition, temporarily supplies power to the NVRAM, to store a log file associated with the reception of the instant-on command, the predetermined condition including at least one of a condition that the external system is a system registered in advance and a condition that the instant-on command is in a pattern registered in advance.

40. At least one medium comprising computer readable instructions implementing the method of claim 26.
